(19) United States
(12) Patent Application Publication
(10) Pub. No.: US 2008/0022336 A1
(43) Pub. Date: Jan. 24, 2008

(54) Set-top box network diagnostics

(75) Inventors: Jerald Robert Howcroft, Beverly Hills, MI (US); Keith Crowe, Austin, TX (US); Kathy Goode Piatt, Cedar Park, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/481,418

(22) Filed: Jul. 5, 2006

(51) Int. Cl. H04N 7/173; H04N 7/16

(52) U.S. Cl. 725/100; 725/131; 725/139; 725/108

(57) ABSTRACT

A set-top box (STB) is disclosed. The STB includes a network interface to send signals to and receive signals from a network. The STB also includes a tuner to send a display signal to a display device based on a signal received by the STB. The STB also includes a user interface display module to send a user interface display to the display device and to receive user input. The STB also includes a diagnostic module to generate a network diagnostic command and to send the network diagnostic command to a first network device. The network diagnostic command is configured to solicit a response from the first network device. The diagnostic module is configured to determine a status of a network connection from the STB to a remote network device based on the network diagnostic command and the response received from the first network device.

### FIELD OF THE DISCLOSURE

The present disclosure is generally related to computer networks and to set-top boxes coupled to computer networks.

### BACKGROUND

Set-top boxes (STBs) are commonly used to access a variety of services that require access to resources on a network. Both STBs themselves and the networks they access fail at times. Users that rely on STBs to access network services can become frustrated when these services are not available due to problems with the STB or the network. Service providers often have diagnostic resources available on the network side to help them troubleshoot network problems. However, users do not have direct access to these network diagnostic resources. As a result, the users are left with little recourse to correct or identify network problems but to call the service provider.

### BRIEF DESCRIPTION OF THE DRAWINGS

FIG. 1 is a block diagram of an embodiment of a network connected to a set-top box;

FIG. 2 is another embodiment of a network connected to a set-top box;

FIG. 3 is a block diagram of an exemplary embodiment of a STB;

FIG. 4 is an exemplary embodiment of a user interface display;

FIG. 5 is an exemplary embodiment of a user interface display including a report of network diagnostic results;

FIG. 6 is flow chart of an exemplary embodiment of a method of diagnosing a network connection to a STB;

FIG. 7 is a flow chart of another exemplary embodiment of a method of diagnosing a network connection to a STB; and

FIG. 8 is an illustrative embodiment of a general computer system.

### DETAILED DESCRIPTION OF THE DRAWINGS

Set-top boxes (STBs) may be used to access a variety of services that require access to resources on a network. Examples of services that may be provided via a STB include, but are not limited to, video on demand, email, photo sharing, and downloading music. Users that rely on STBs to access these services can become frustrated when the services are not available due to problems with the STB or the network. Service providers often have diagnostic resources available to help users troubleshoot network problems. Embodiments disclosed herein include methods and systems of providing diagnostic resources to STB users by storing and running the diagnostic resources from the STB. Such embodiments may help the STB user and/or the service provider support staff to have a better understanding of any problems with the STB or network, and to more quickly resolve those problems.

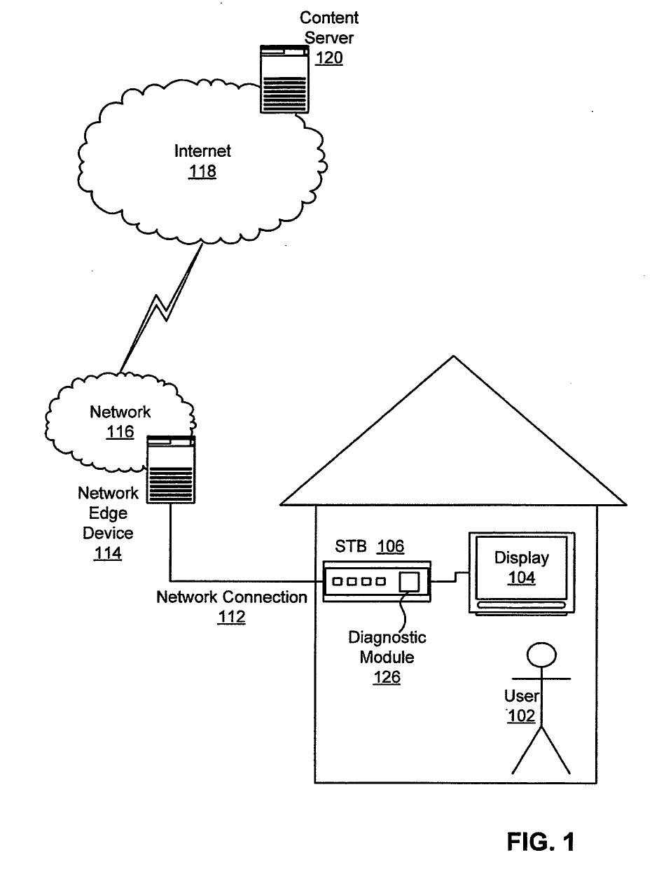

FIG. 1 is a block diagram of an embodiment of a system that includes a network 116 connected to a set-top box (STB) 106. In the particular arrangement shown, the STB 106 is communicatively coupled to a display 104. The display 104 may include a computer display, a television, or other device configured to display information to a user 102.

The STB 106 may be coupled to the network 116 via a network connection 112. The network 116 includes at least one network device that communicates with the STB 106 via the network connection 112. The network device that communicates directly with a device in the user's residence (such as STB 106) may be referred to as a network edge device 114.

The network 116 may also include or be connected to a content server 120. For example, the content server 120 may be connected to the network 116 via the Internet 118, or via another local, wide area, or global network. The content server 120 may be configured to send information to users through one or more networks.

In a particular illustrative embodiment, the STB 106 may include a network diagnostic module 126. The STB 106 may be configured to receive a command from the user 102 to diagnose network communications. In response to the STB 106 receiving such a command, the network diagnostic module 126 may send one or more network diagnostic commands to at least one network device. For example, the network diagnostic module 126 may send a network diagnostic command to the network edge device 114 or the content server 120. The STB 106 may determine a network status based on responses to the network diagnostic command or commands sent.

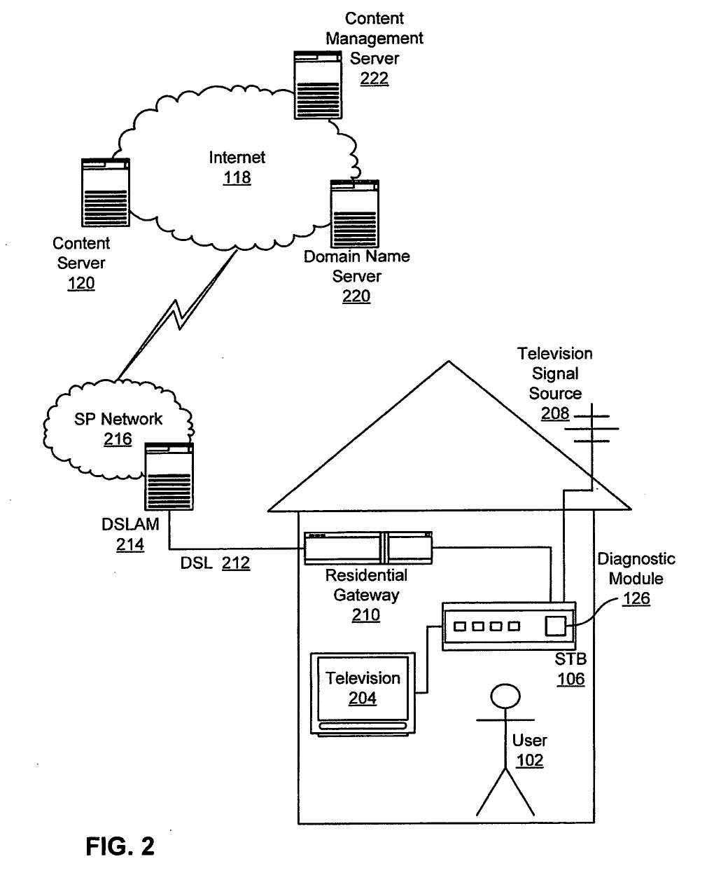

FIG. 2 depicts another embodiment of a system that includes a network connected to a STB. The particular network arrangement depicted in FIG. 2 includes a STB 106 in communication with a remote network device (such as content server 120) via a first network device (such as residential gateway 210, DSLAM 214, domain name server 220, or content management server 222).

The STB 106 is connected to a television 204. The STB 106 may provide information to the television 204 for display to a user 102. The STB may also receive television signals from a television signal source 208 and communicate the television signals to the television 204. In various embodiments, television signal sources may include a television antenna receiving, for example, broadcast or satellite television signals; a remote network device sending, for example, video-on-demand, cable or internet protocol television (IPTV) signals; a home entertaimnent device, for example, a digital video disk (DVD) player; or any other source of a television signal.

In a particular illustrative embodiment, the STB 106 may communicate with a service provider network 216 via the residential gateway 210. The residential gateway 210 may be connected to the digital subscriber line access multiplexer (DSLAM) 214 via a digital subscriber line (DSL) 212. As used herein, DSL includes any of a variety of technologies in which broadband communications are provided to a customer using telephone lines. Examples of technologies included in the term DSL include, but are not limited to: High-bit-rate Digital Subscriber Line (HDSL), Symmetric Digital Subscriber Line (SDSL), Asymmetric Digital Subscriber Line (ADSL), Rate-Adaptive Digital Subscriber Line (RADSL), Very-high-bit-rate Digital Subscriber Line (VDSL), Very-high-bit-rate Digital Subscriber Line 2 (VDSL2), G. Symmetric High-speed Digital Subscriber Line (G.SHDSL), and Powerline Digital Subscriber Line (PDSL). In DSL systems, generally a device referred to herein as a DSLAM 214 acts as a network edge device, providing users access to the service provider's network 216.

The service provider network 216 includes or is connected to the content server 120. For example, in a particular illustrative embodiment, the service provider network 216 may be connected to the Internet 118. In such an embodiment, the content server 120 may be in communication with the service provider network 216 via the Internet 118.

The content server 120 may communicate information, data, instructions or other content to the user or to one or more network devices via a network. For example, in various embodiments, the content server 120 may communicate one or more of video data, graphic data, text data, sound data, etc. The content management server 222 may control access to the content served by the content server 120. For example, the content management server 222 may limit access to the content to authorized users, and may gather access information for purposes such as billing users for access to content.

Users attempting to access resources on a network typically prefer to view network addresses as text; however, network devices typically work with network addresses as numbers. One service provided by domain name servers (DNS) 220 is to translate text network addresses into numeric addresses. For example, if the user 102 sends a request to access content on content server 120, DNS 220 may provide information to direct the request to the proper device or devices on the network.

The user 102 may experience difficulties in accessing content from the content server 120 due to problems with any of the network devices depicted in FIG. 2, or other network devices. In a particular illustrative embodiment, the STB 106 includes a network diagnostic module 126 to give the STB 106 on-board network diagnostic capabilities. The network diagnostic module 126 may allow the user 102 to initiate network diagnostics directly from the STB 106 without requiring that the service provider's technical support contact run network diagnostics from the service provider network 216. Since certain of these network devices are largely within the control of the user 102, such as the residential gateway 210 and STB 106, the user 102 may be able to resolve network problems without contacting the service provider at all. Even if the user 102 must contact the service provider to resolve the network problem, the information provided to the user 102 by the STB 106 reporting the network diagnostic results may be useful to the service provider.

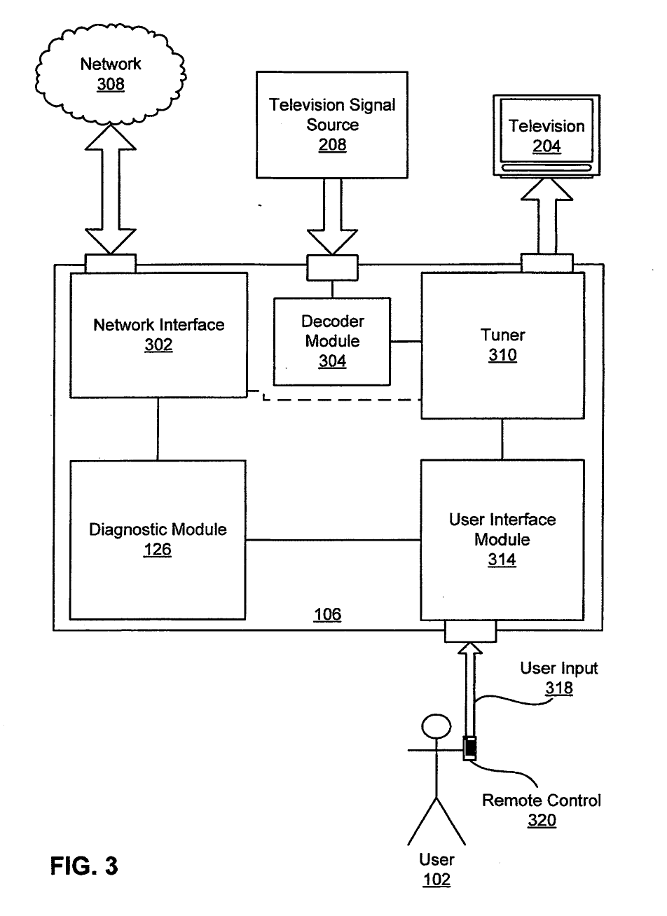

Turning to FIG. 3, a block diagram of an exemplary embodiment of a STB 106 is depicted. The exemplary STB 106 includes a network interface 302. The network interface 302 is capable of sending signals to and receiving signals from a network 308. For example, the network interface may be configured to communicate with a DSLAM via a DSL.

The STB 106 also includes a tuner 310. The tuner 310 may be capable of sending a display signal to a television 204 based on a signal received by the STB 106. For example the tuner 310 may send a signal to the television 204 based on a cable television signal, a satellite television signal, an internet protocol television (IPTV) signal, a television broadcast signal, a home entertainment system device (such as a DVD player), or a television signal received from some other television signal source 208.

In the exemplary embodiment depicted in FIG. 3, the STB 106 also includes a decoder module 304. The decoder module 304 may be capable of decoding an encoded television signal received from the television signal source 208. For example, the decoder module 304 may be capable of decoding an IPTV signal received by the network interface 302 and may communicate the decoded television signal to the tuner 310. The decoder module 304 may also be capable of decoding a television signal encoded, i.e., “scrambled”, to restrict access to the signal.

The STB 106 depicted in FIG. 3 also includes a user interface module 314. The user interface module 314 may be capable of sending a user interface display to the television 204. For example, the user interface module 314 may send a user interface display signal to the tuner 310 which the tuner 310 sends to the television 204. The user interface module 314 may also be capable of receiving user input 318 based on the user interface display. For example, in some embodiments, the user interface module 314 may receive signals sent by a remote control device 320. In such embodiments, the remote control device 320 may control well-known functions of the STB 106, such as channel selection, etc. Additionally, the remote control device 320 may be used by the user 102 to initiate a network diagnostics software application.

The STB 106 may also include a diagnostic module 126. The diagnostic module 126 may be capable of generating a network diagnostic command and sending the network diagnostic command via the network interface 302 to a first network device. The first network device may be any device coupled to the network including the STB itself. For example, if the first network device is the STB 106, the network diagnostic command may include a loopback command, such as an Internet Control Message Protocol (ICMP) ping command to a loopback address, e.g., 127.0.0.1. Such a ping command sent to the loopback address may allow the STB 106 to determine whether one or more network protocols, such as TCP, IP, etc., are installed and correctly configured. In another example where the first network device is the STB 106, the network diagnostic command may include a ping command sent to an Internet protocol (IP) address of the STE 106. Such a ping command sent to the IP address of the STB 106 may allow the STB 106 to determine whether it was added to the network and configured correctly. For example, such a ping command may allow the STB 106 to verify that routing tables in the STB 106 include the IP address of the STB 106. Other examples of devices that may be the first network device include, but are not limited to, the network devices depicted and described with reference to FIGS. 1 and 2. The diagnostic module 126 may send one or more network diagnostic commands to one or more network devices via the network interface 302 in response to the user interface module 314 receiving a command from the user 102 to initiate network diagnostics.

In a particular illustrative embodiment, the network diagnostic command generated by the diagnostic module 126 may be configured to solicit a response from the first network device. Examples of network diagnostic commands that may be generated by the diagnostic module 126 in various embodiments include, but are not limited to: ping commands, trace route commands, and network information requests, such as queries regarding the status of various network devices and connection, and queries regarding network or network device configuration information, e.g., IP address, Network mask, default gateway, DNS server.

In a particular illustrative embodiment, the diagnostic module 126 may be configured to generate a plurality of network diagnostic commands. The diagnostic module 126 may generate one or more network diagnostic solicitation commands to solicit a response from each of a plurality of identified network devices of the network connecting the STB 106 and the remote network device. For example, the diagnostic module 126 may access a memory that includes a static or dynamic list identifying devices of the network connecting the STB 106 to one or more remote network devices. The list may include all of the devices connecting the STB 106 to the remote network device, or only a subset of devices connecting the STB 106 to the remote network device. The diagnostic module 126 may be configured to generate a diagnostic solicitation command for each device on the list of identified network devices, or only a subset of the identified network devices.

In a particular illustrative embodiment, the network diagnostic commands sent by the STB 106 may include, for example, a ping command sent to a default gateway address. Such a ping command may enable the STB 106 to determine whether a residential gateway is functioning and/or whether the default gateway address is configured properly. Another example of a network diagnostic command that may be sent by the STB 106 includes a network information request sent to the residential gateway. Such a network information request may include a query to determine whether a digital subscriber line coupled to the residential gateway is functional. The STB 106 may also send network diagnostic commands to devices on the service provider network. For example, the network diagnostic commands sent by the STB 106 may include a ping command and/or a trace route command sent to a service provider network address. Such a network diagnostic command may enable the STB 106 to determine whether the STB 106 can communicate with the service provider network, and more particularly, with a network device at the specified service provider network address. The STB 106 may also send network diagnostic commands to network devices that are not part of the service provider network, that is, that are not under the control of the service provider. For example, the STB 106 may send a ping command to any network device. In a particular illustrative embodiment, the STB 106 may send a ping command to a remote netwvork device and specify the network address of the remote network device as a text address. Such a ping command may enable the STB 106 to determine whether a DNS translates the text address into a numeric address, and to determine whether the STB 106 can communicate with the remote network device.

The diagnostic module 126 may be configured to determine the status of a network connection from the STB 106 to a remote network device based on the network diagnostic command and based on one or more responses received from one or more first network devices. The remote network device may be any network device in communication with the STB. Examples of devices that may be the remote network device include, but are not limited to the network devices depicted and described with reference to FIGS. 1 and 2.

In a particular illustrative embodiment, the diagnostic module 126 may also be capable of generating a report indicating the status of the network connection. As used herein, the term “network connection” refers to an ability of two or more network devices to communicate with one another. A network connection is not limited to any particular type of connection or physical or electrical coupling of the devices. Rather, if the devices are able to communicate data in some fashion, they are said to have a network connection. The status of the network connection refers to whether the devices can communicate with one another, and whether the communications are as expected. The diagnostic module 126 may display the report to the user 102 of the STB 106. For example, the report may be displayed on a display device connected to the STB 106, such as the television 204. In a particular illustrative embodiment, the report indicating the status of the network connection may include a recommended course of action to correct an identified problem with the network connection.

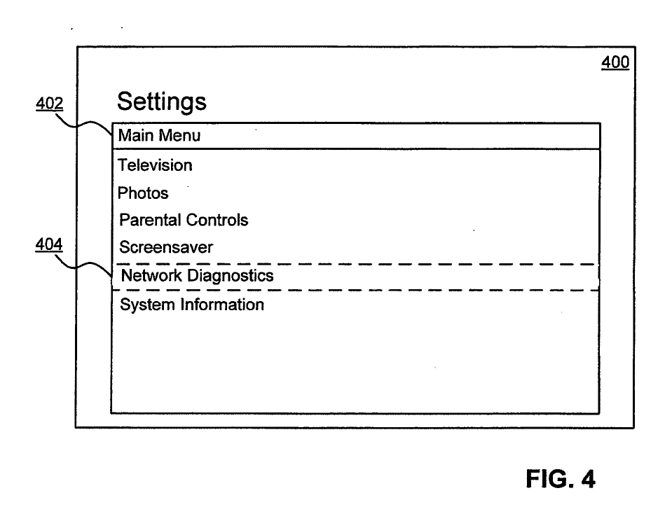

FIG. 4 depicts an exemplary embodiment of a user interface display 400. The user interface display 400 may be displayed, for example, on a television coupled to a STB, such as the STB 106 discussed above with reference to FIG. 3. The user interface display 400 includes a user selectable menu 402 with a “Network Diagnostics” menu item 404. Selecting the network diagnostics menu item 404 may initiate a network diagnostic software application on the STB.

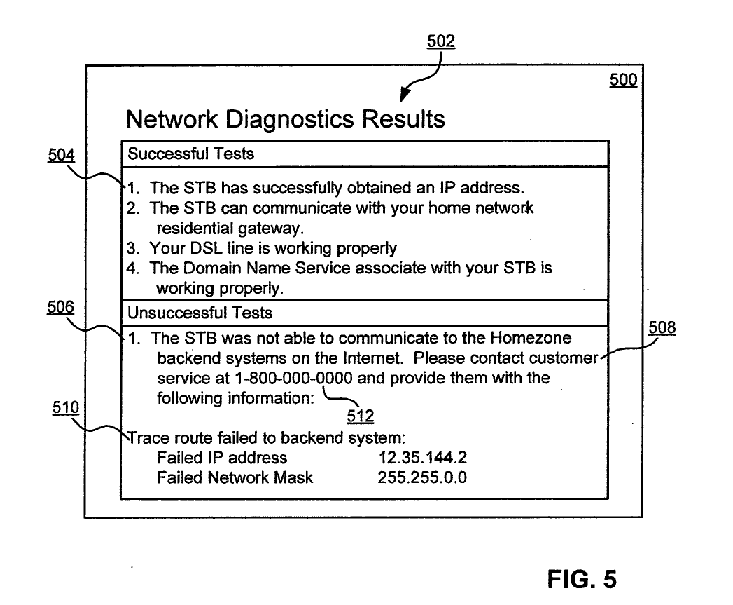

FIG. 5 depicts an exemplary embodiment of a user interface display 500 including a report of network diagnostic results 502. The user interface display 500 may be displayed, for example, on a television coupled to a STB, such as the STB 106 discussed above with reference to FIG. 3. The report of network diagnostic 502 results includes a successful tests portion 504 where successful diagnostic tests may be reported. For example, the successful tests portion 504 may include an indication that at least one network device of a network accessible by the STB is communicating with the STB.

The report of network diagnostic results 502 also includes an unsuccessful tests portion 506 where unsuccessful diagnostic tests may be reported. For example, the unsuccessful tests portion 506 may include one or more error messages. The one or more error messages may, for example, indicate that there is a communication error between the STB and one or more other network devices. The report of network diagnostic results may also include a recommended course of action 508 to correct one or more unsuccessful diagnostic tests, such as communication errors. In a particular illustrative embodiment, such a recommended course of action 508 may include a description of unsuccessful test results 510 and contact information 512 for a technical support contact.

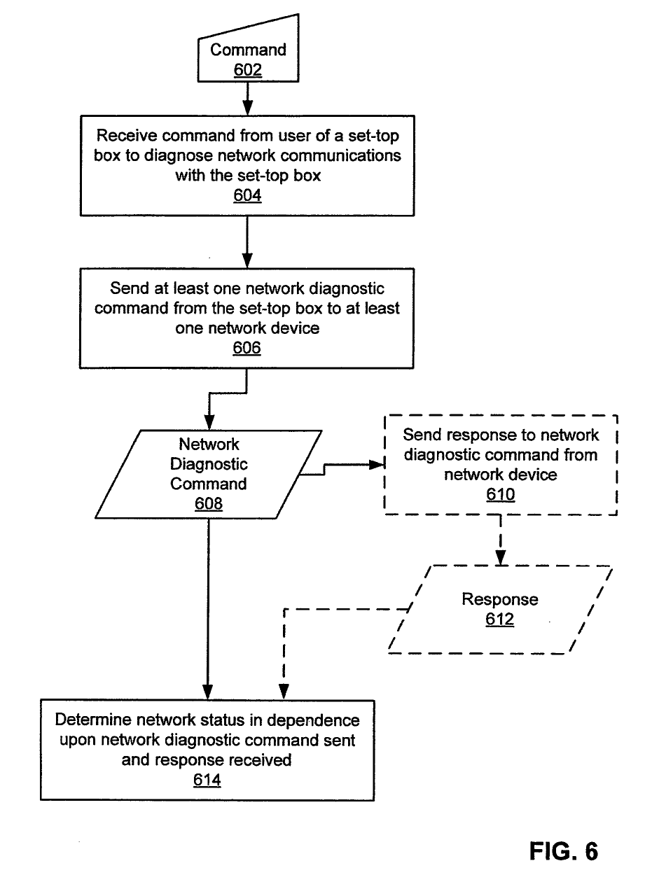

FIG. 6 depicts a flow chart of an exemplary embodiment of a method of diagnosing a network connection to a STB. The method depicted includes receiving 604 a command 602 from a user of a STB to diagnose network communications with the STB. The method also includes sending 606 at least one network diagnostic command 608 from the STB to at least one network device. Assuming the STB is in communication with the network device(s) that the network diagnostic command 608 is sent to, and further assuming that the network device(s) are working properly, the network device(s) may send 610 a response 612 to the network diagnostic command. The method also includes determining 614 a network status in dependence upon the network diagnostic commands sent and the responses received. If no response 612 is received, the method may determine the network status based on the network diagnostic commands sent, and the fact that no response was received.

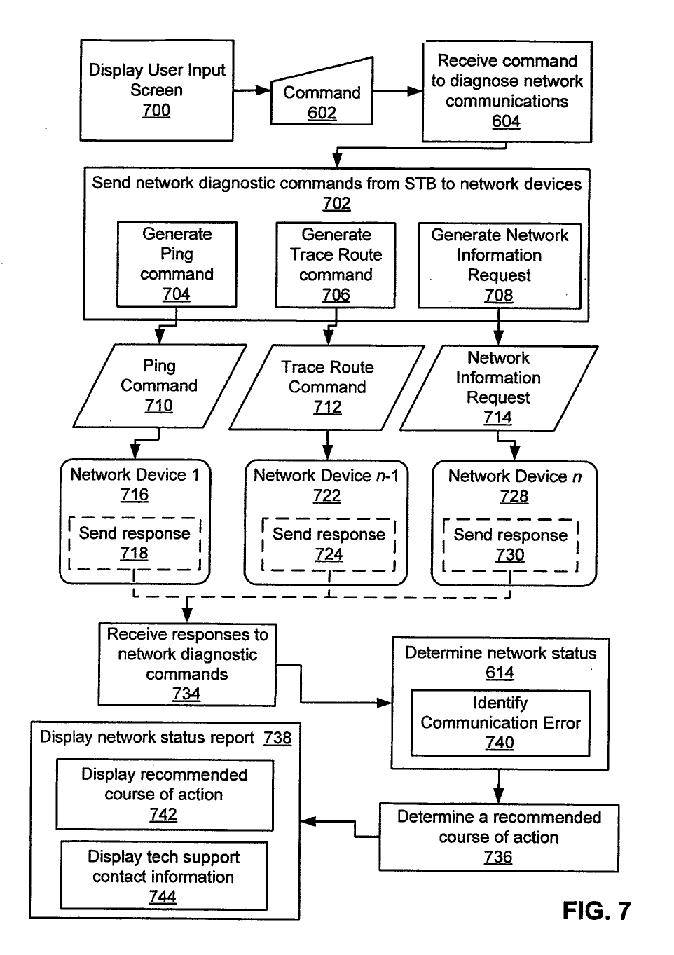

FIG. 7 depicts a flow chart of another exemplary embodiment of a method of diagnosing a network connection to a STB. The method includes displaying 700 a user input screen to a user. For example, the user input screen may include a user interface display 400, as depicted in FIG. 4. The user input screen may allow the user to initiate a network diagnostic software application by sending a command 602 to the STB to initiate the network diagnostic software application. In other embodiments, the user may initiate the network diagnostics software application by other methods such as via a hardware interface, e.g., by selecting a network diagnostic button on a STB or keypad.

Upon receiving 604 the command 602 to diagnose network communications, the network diagnostic software application onboard the STB may generate and send 702 at least one network diagnostic command from the STB to at least one network device. For example, a network diagnostic command generated and/or sent may include a communication to a network device that is configured to solicit a response from the network device. In the exemplary embodiment depicted in FIG. 7, sending 702 network diagnostic commands from the STB to network devices includes one or more of generating 704 a ping command 710, generating 706 a trace route command 712, and generating 708 a network information request 714.

The network diagnostic commands may be sent to a plurality of network devices including network device 1 716, network device n-1 722 and network device n 728, where n may be any number up to the total number of network devices of the network. The network devices to which diagnostic commands are sent may vary from installation to installation based on the specific configuration of the network and the preferences of a network administrator or the user. Examples of network devices include, but are not limited to: STBs, residential gateways, domain name servers, network edge servers, content servers, content management servers, or other remote or local network devices, such as those depicted in FIGS. 1 and 2.

If a network device is functioning properly and receives the network diagnostic commands sent to it, it may send a response. The response sent by each network device may depend on the network diagnostic command sent. For example, in response to the ping command 710 sent to network device 1 716, the network device 1 716 may send a ping response 718. In various embodiments, the STB may send ping commands to, for example, itself (as a loopback command, or at the STB's local network address), the residential gateway, a network edge device, another service provider network device, a DNS server, a content server, a content management server, etc.

Similarly, in response to a trace route command 712, the network device n-1 722 may send a trace route response 724. For example, a trace route command may be sent to a device on a service provider network to verify the connection to the service provider network. By its nature, a trace route response 724 from network device n-1 may be forwarded to another network device (not shown) of the network which may also generate a trace route response and send the new trace route response on to another network device. Eventually, if the communication path is complete, the trace route response may arrive at the STB. The trace route response that arrives at the STB may include information about each network device that received the trace route command and that sent a trace route response.

In still another example, in response to receiving a network information request 714, the network device n 728 may generate and send a network information response 730. In a particular illustrative embodiment, a network information request 714 may include any communication requesting network configuration information. The requested network configuration information may include for example, an IP address, a network mask, a default gateway identification, a DNS server identification, etc.

The method also includes receiving 734 responses to network diagnostic commands. If one or more network diagnostic tests are unsuccessful, it is possible that no responses will be received. Whether responses are received or not, the method may include determining 614 the network status. The network status refers to whether one or more devices or network connections of the network appear to be functioning. The network status may be determined, for example, based on whether expected responses were received and whether responses that were received were as expected.

Determining 614 the network status may include identifying 740 one or more communication errors. Identifying 740 communication errors may include, for example, determining that one or more expected responses were not received and identifying which device(s) the STB does not appear to have proper communications with based on whether the expected responses were received. Identifying 740 communications errors may also include, for example, determining that one or more received responses were not as expected and identifying which device(s) the STB does not appear to have proper communications with based on the responses that were not as expected. Examples of a received response not being as expected include situations such as: a received response taking longer than an expected amount of time, a received response including unexpected information, a received response omitting expected information, or a received response having an improper format.

The method also includes determining 736 a recommended course of action based on the network status. The recommended course of action may, for example, instruct the user to perform specified network repair steps, or to contact a technical support contact. The recommended course of action may be displayed 742 to the user as part of displaying 738 a network status report. Displaying 738 the network status report may also include displaying 744 contact information for a technical support contact. The technical support contact may be associated with the STB, the network, or a particular network device with which the STB appears to not have proper communications.

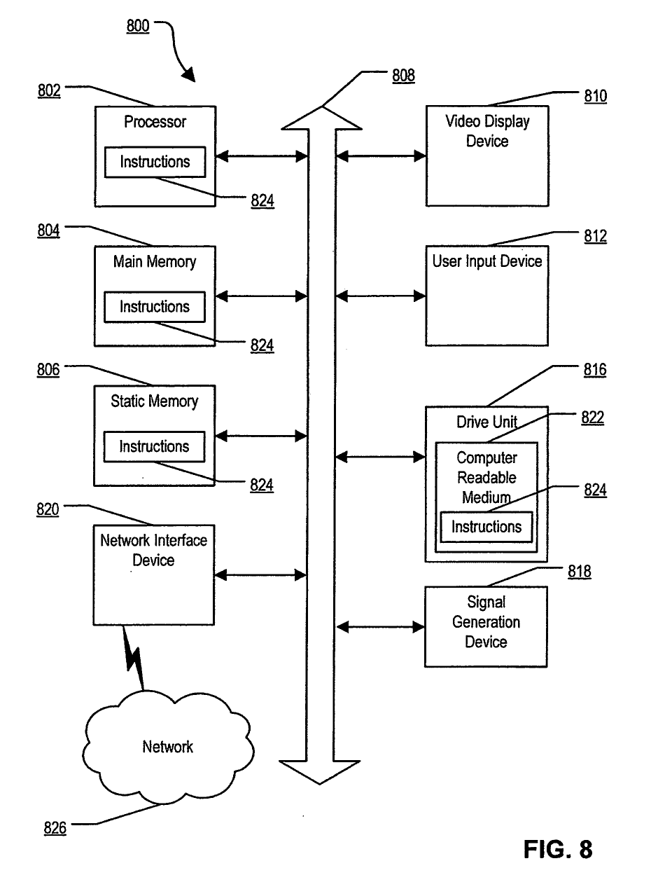

Referring to FIG. 8, an illustrative embodiment of a general computer system is shown and is designated 800. In various illustrative embodiments, one or more network devices, such as those depicted in FIGS. 1 and 2, may include all or some of the components of the computer system 800. Additionally, in various illustrative embodiments, the STB 106, depicted in FIGS. 1, 2 and 3, or components of the STB 106, may be implemented in hardware or software including all or some of the components of computer system 800.

The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a STB, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806, that can communicate with each other via a bus 808. As shown, the computer system 800 may further include or be in communication a video display device 810, such as a liquid crystal display (LCD), an organic light emitting diode (OLED), a flat panel display, a solid state display, or a cathode ray tube (CRT). Additionally, the computer system 800 may include or be in communication with a user input device 812, such as a keyboard or remote control. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by the computer system 800. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A set-top box comprising:
a network interface capable of sending signals to and receiving signals from a network;
a tuner capable of sending a display signal to a display device based on a signal received by the set-top box;
a user interface display module capable of sending a user interface display to the display device via the tuner and capable of receiving user input; and
a diagnostic module capable of generating a network diagnostic command and sending the network diagnostic command via the network interface to a first network device, wherein the network diagnostic command is configured to solicit a response from the first network device, and wherein the diagnostic module is configured to determine a status of a network connection from the set-top box to a remote network device based on the network diagnostic command and the response received from the first network device.

2. The set-top box of claim 1, wherein the first network device is the network interface and the network diagnostic command is a loopback command.

3. The set-top box of claim 1, wherein the network diagnostic command includes a ping command.

4. The set-top box of claim 1, wherein the network diagnostic command includes a trace route command.

5. The set-top box of claim 1, wherein the network diagnostic command includes a network information request.

6. The set-top box of claim 1, wherein the network diagnostic command includes a ping command sent to a default gateway address to determine whether a residential gateway is functioning and whether the default gateway address is configured properly.

7. The set-top box of claim 1, wherein the network diagnostic command includes a ping command sent to a loopback address of the set-top box to determine whether one or more network protocols are installed and correctly configured

8. The set-top box of claim 1, wherein the network diagnostic command includes a ping command sent to an internet protocol address of the set-top box.

9. The set-top box of claim 1, wherein the network diagnostic command includes a network information request sent to a residential gateway, wherein the network information request includes a query to determine whether a digital subscriber line coupled to the residential gateway is functional.

10. The set-top box of claim 1, wherein the network diagnostic command includes a ping command sent to a service provider network address to determine whether the set-top box can communicate with a network device at the service provider network address.

11. The set-top box of claim 1, wherein the network diagnostic command includes a trace route command sent to a service provider network address.

12. The set-top box of claim 1, wherein the network diagnostic command includes a ping command sent to a network address specified as a text address to determine whether a domain name server translates the text address to a numeric network address.

13. The set-top box of claim 1, wherein the diagnostic module is further configured to generate a plurality of network diagnostic commands, including at least one network diagnostic solicitation command to solicit a response from each of a plurality of identified network devices of the network.

14. The set-top box of claim 1, wherein the diagnostic module is further capable of generating a report indicating the status of the network connection and displaying the report to a user of the set-top box on the display device.

15. The set-top box of claim 14, wherein the report indicating the status of the netwvork connection includes a recommended course of action to correct an identified problem with the network connection.

16. The set-top box of claim 1, further comprising a decoder module capable of decoding an encoded television signal received from a television signal source via the network interface.

17. A display comprising:
an indication that at least one first network device of a network accessible by a set-top box is communicating with the set-top box;
at least one error message indicating at least one communication error between the set-top box and at least one second network device on the network; and
a recommended course of action to correct the at least one communication error.

18. A method of diagnosing a network connection at a set-top box, the method comprising:
receiving a command from a user of a set-top box to diagnose network communications with the set-top box;
sending at least one network diagnostic command from the set-top box to at least one network device; and
determining a network status based on a response to the at least one network diagnostic command.

19. The method of claim 18, further comprising determining a recommended course of action based on the network status, and displaying the recommended course of action to the user.

20. The method of claim 18, wherein determining the network status includes identifying at least one communication error between a first network device and the set-top box.

21. The method of claim 20, further comprising displaying contact information for a technical support contact associated with the first network device.

22. The method of claim 18, wherein the at least one network diagnostic command includes at least one ping command, at least one trace route command, and at least one network information request command.

23. The method of claim 18, wherein the at least one network device includes a residential gateway.

24. The method of claim 18, wherein the at least one network device includes a domain name server.

25. A set-top box comprising:
a network interface capable of sending signals to and receiving signals from a network;
a tuner capable of sending a signal to a television; and
a diagnostic module capable of sending at least one ping command to at least one network device via the network interface.

26. The set-top box of claim 25, wherein the diagnostic module is further capable of sending at least one trace route command to the at least one network device via the network interface.

27. The set-top box of claim 25, wherein the diagnostic module is further capable of sending at least one network status request to the at least one network device via the network interface.

28. The set-top box of claim 25, further comprising a decoder module capable of decoding an encoded television signal received from a television signal source.

29. A computer readable medium tangibly embodying a program of instructions to manipulate a computing platform to:
receive a command from a user of a set-top box to diagnose network communications with the set-top box;
send at least one network diagnostic command from the set-top box to at least one network device; and
determine a network status based on a response to the at least one network diagnostic command.
